(19) United States
(12) Patent Application Publication
(10) Pub. No.: US 2012/0221443 A1
(43) Pub. Date: Aug. 30, 2012

(54) Method and Apparatus for Providing Production Information

(76) Inventor: Bruce Macmillan, (US)

(21) Appl. No.: 13/035,746

(22) Filed: Feb. 25, 2011

(51) Int. Cl. G06Q 10/00

(52) U.S. Cl. 705/28

(57) ABSTRACT

Methods and apparatus are described for comparing and validating information provided by a manufacturer of an individual product item against information provided by a trusted third-party. The information provided by the manufacturer includes an identifier of the individual product item. The information provided by the manufacturer is stored and associated with the information provided by the trusted third-party in a database. When a request for information that includes data representing the identifier is received from a potential purchaser of the individual product item, information associated with the individual product item is looked up in the database using the identifier. At least part of the information associated with the individual product item is transmitted to the potential purchaser. Upon purchase of the individual product item, the identifier can be used to link ownership information provided by the purchaser to the individual product item in the database.

### BACKGROUND

1. Field of Art

The present invention relates generally to methods and apparatus for providing product information.

2. Background of the Invention

When buying products, from foods to electrical items, many consumers want, either prior to or at the point of purchase, to discover more information about the products in order to exercise an informed decision as to which products to buy. If consumers can get answers to questions such as, “What is it?”, “Where is it from?”, “When was it made?”, “Who made it?” and “Was the way in which it was made ethical?”, then it might shape their current and future purchasing decisions—who they shop from, whose products they buy and how they let their ethical and environmental interests dictate their purchasing choices.

If these questions can be answered quickly and easily, in real-time and at the point-of-sale, then soon it might become unacceptable to many consumers to not know these facts about their intended purchases, and so products that cannot be checked in this way might not get purchased. Similarly, retailers may look to make a virtue of good knowledge existing on the products that they sell (especially if the cost of providing this information is minimal for the retailer) and this would drive back to manufacturers and producers—consumer knowledge would be power in the hands of the consumer and driven back up the retail and manufacturing chain—first to know the first four questions listed above and then finally to exercise individual judgement on what matters to the consumer about the ethical question stated above.

Existing product labels make a range of environmental, ethical and social claims. For example, printed labels on food products inform consumers about the origin of the product, whether it has been produced organically and its carbon footprint. However, such labels often contain confusing or unsubstantiated claims from the producer.

It would therefore be desirable to provide information that is independently held, easily accessible and reliable.

### SUMMARY

Apparatus and method embodiments described herein allow for a purchaser, such as a consumer or retailer, to obtain, in a simple way and possibly in real time, factual and qualitative information about a particular product item that they are considering purchasing.

In one particular embodiment, information relating to products and product supply chain operations is received from one or more sources. The one or more sources comprise at least one of a trusted third-party information provider and an entity associated with the products and product supply chain operations. Information relating to an individual product item and a corresponding supply chain operation is received from a particular entity associated with the individual product item and the corresponding supply chain operation. The information relating to the individual product item includes an identifier of the individual product item. The information received from the one or more sources and the information received from the particular entity are stored and associated in a database. When a request for information including the identifier is received from a potential purchaser of the individual product item, information associated with the individual product item is looked up in the database, using the identifier. At least part of the information associated with the individual product item is transmitted to the potential purchaser.

Thus, the information supplied by a manufacturer can be compared and validated at least in part against an independent, reputable source.

Apparatus and method embodiments described herein also allow for an auditable trail of product ownership.

In one particular embodiment, information relating to an individual product item is received from a first entity associated with manufacturing of the individual product item. The information relating to the individual product item includes characteristic information about the individual product item and an identifier unique to the individual product item. The characteristic information and the identifier are stored and associated in a database. Information is received from the first entity indicating a transfer of ownership of the individual product item to a second entity, the information received from the first entity including the identifier. Information identifying the second entity is also received from the first entity or from the second entity. The information identifying the second entity is stored and associated in the database with the characteristic information and with the identifier.

Thus, an individual product item can be uniquely identified and the ownership trail followed.

### BRIEF DESCRIPTION OF DRAWINGS

Various embodiments are described in detail below with reference to accompanying drawings, in which:

FIG. 1 is a schematic diagram of a system in which product information can be provided and verified according to an embodiment;

FIG. 2 is a schematic diagram of a product information system according to an embodiment;

FIG. 3 is a flow diagram illustrating the steps performed by a manufacturer during online registration according to an embodiment;

FIG. 4 is a process flow diagram illustrating the steps of matching products with information according to an embodiment;

FIG. 5 is a process flow diagram illustrating the steps of providing information to consumers at a point of purchase according to an embodiment;

FIG. 6 is a schematic diagram of the interactions in a system in which product information can be provided and verified according to an embodiment;

FIG. 7 is a schematic diagram of the interactions in a system in which ownership information can recorded according to an embodiment; and

FIG. 8 is a schematic diagram showing how information can be provided according to an embodiment.

While multiple embodiments are disclosed herein, still other embodiments will become apparent to those skilled in the art from the following detailed description, which describes illustrative embodiments. As will be realized by those of ordinary skill in the art upon reading the following disclosure, embodiments are capable of modifications in various aspects, all without departing from the spirit and scope of the present invention as defined in the appended claims. Accordingly, the drawings and detailed description are to be regarded as illustrative in nature and not restrictive.

### DETAILED DESCRIPTION OF EMBODIMENTS

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

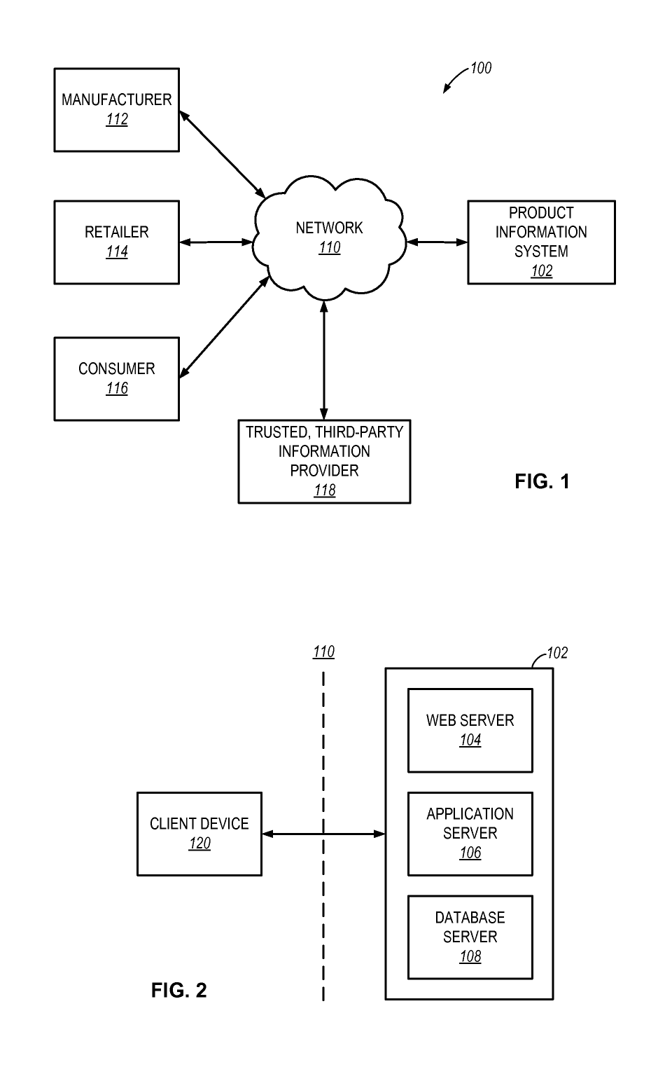

Referring now to the Figures, wherein like reference numerals are used to identify like components in the various views, FIG. 1 illustrates a system 100 in which product information can be provided and verified according to an embodiment. System 100 includes a product information system 102 that gathers information from one or more entities associated with products and product supply chain operations, such as, but not limited to, a manufacturer 112, and from a trusted third-party information provider 118, and distributes the information to requesting entities, such as, but not limited to, retailers 114 and consumers 116. Thus, product information system 102 is configured to interact with a variety of different entities over a network 110, which can be a local or wide area network (such as the Internet) to receive, store, organise, and, as appropriate, distribute selected information. The selected information can include request-selected information, pre-selected information, or dynamically-selected information. System 100 is suitable for, but not limited to, providing information at a point-of-sale about goods that are tangible (i.e. have a physical structure).

It will be appreciated that some business entities do not have a manufacturing or distribution infrastructure, but instead have agreements with contract manufacturers who supply part products and with other parties who assemble, package and distribute the final products. Thus some business entities may merely coordinate supply chain operations, for example from the initial supplier to the final customer, and which may include any one or more of supplying, manufacturing and distributing of the products. For convenience only, and not by way of limitation, the following description refers to the business entities as “manufacturers”, irrespective of whether or not they have a manufacturing or distribution infrastructure. Thus, where reference is made, for example, to information provided by a manufacturer, it will be understood that this may encompass information related to product distribution, for example product shipping information.

Product information system 102 may be implemented in a variety of computing configurations, such as one or more computing devices (e.g. servers) each having one or more processors configured by programming instructions (i.e. software) to perform the functions described herein. For example, as shown in FIG. 2, the product information system 102 comprises a Web server 104, an application server 106, and a database server 108. The Web server hosts the web pages, applications (services) and parts necessary to process requests received from client device 120. The Web server 104 directs these requests to the application server 106, which provides application-specific functionality and returns the results to the Web server 104. The application server 106 may reside in the same computer as the Web server 104 or be in a separate computer. Multiple computers may be used for both application servers and Web servers. Database server 108 provides database functionality, such as data indexing, querying and retrieval. Servers 104, 106, 108 can communicate with one another over a network (not shown) such as a local area network (LAN) or wide area network (WAN). The information stored in database server 108 will vary depending on, for example, the manufacturer and the products produced by the manufacturers, and it will be apparent that the particular information provided in the following description is not meant to be exhaustive, but rather illustrative.

Client device 120 is a computer device, such as a desktop or laptop computer, personal data assistant, tablet, mobile phone, and the like, that allows a user of the device access to the product information system 102 over network 110. This includes, for example, automated interactive telephony technology based on key pad or speech recognition based responses to user commands. Client devices typically include a processor, a memory (such as a random access memory (RAM) or other storage device for storing information and instructions to be executed by the processor), input/output components (such as a mouse, keyboard and/or (touch) screen), and a network interface. However, different client device implementations may include additional, fewer, or different components.

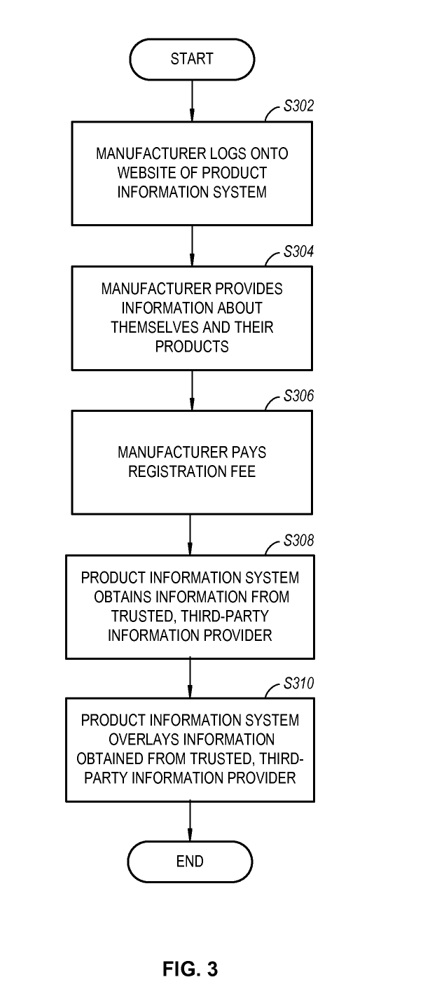

FIGS. 3 to 5 are flow diagrams illustrating exemplary processes of system 100, beginning with product manufacturer registration and ending with a consumer's purchase and optional “marking” of a product on the system to signify their ownership of it. Although specific steps are disclosed in each of these flowcharts, it will be understood that such steps are exemplary, and embodiments may include additional, fewer, or different steps. It will also be appreciated that the steps in these flowcharts may be performed in an order different from that presented.

FIG. 3 is a flow diagram illustrating the steps performed by a manufacturer during registration according to an embodiment. The process begins at block S302 with the manufacturer logging on to the website of product information system 102. At block 304, the manufacturer provides information about themselves and their products. In embodiments, the information provided by the manufacturer is categorized into one or more of: ‘mandatory’ or optional information, information that is to be made available to the public or information that is to be kept private, information that is to be made available free of charge or made available only on payment of a fee, and technical-related information or business-related information such as economic information and market information. As used herein, “mandatory information” means that the information should be provided whenever applicable (though there may be cases where particular information is not applicable or required even though it is “mandatory”). In embodiments, the absence of such information will subsequently be evident. As used herein, “optional information” means information that may be provided.

By way of example only, mandatory non-public information can include, but is not limited to, manufacturer name, address, contact details, registration number, sales tax number, payment details, manufacturing locations and volumes of output by location and type and volume of products manufactured, as well as accountant's, lawyer's and corporate secretary's details.

Mandatory public information can include, but is not limited to, manufacturer brand name, contact details per country in which sales are made. Generally, such information can be publicly verified by a third party.

Optional, free of charge, publicly accessible information can include, but is not limited to, accreditations for quality, safety, environment, and good working practices, health and safety records, criminal prosecutions records as a company, salary levels per grade of employee and types of employee used on each activity (inc. benefits etc), locations of factories and which goods are manufactured, key suppliers and links to get more details from those suppliers, published accounts and other statutory records.

Optional information (chargeable to the manufacturer) can include, but is not limited to, translations of any of the aforementioned information for target markets where goods are sold, link to virtual factory tours or real time webcam views of factories in which product is manufactured, link to intermediated, product-related question-and-answer service on a range of topics such as product support (which may include chargeable translation service), summary comparisons of the individual company's information against independent third-party information (as is described below), and any other information that provides details about how products get from the manufacturer to the consumer.

In embodiments, the manufacturer agrees to keep the aforementioned information no more than two months out of date, and log any changes that have been made (though this can be performed automatically). The manufacturer may also have to agree that not keeping records up to date, or being found on a spot visit by a third party inspector to have lied or been materially inaccurate, will result in a quality warning being displayed on their information. Completeness, up-to-dateness and accuracy of information supplied (but not ethical or environmental judgements) can be scored so that a manufacturer would be incented to keep a good current and future record.

At block S306, the manufacturer pays a registration fee. An annual renewal fee may also be charged and charges will be made for other services and information fields provided as mentioned herein.

At block S308, the information provided by the manufacturer is compared against local market average data and target market analogous data for similar work. Such location specific and commodity specific comparison information may already be available to product information system 102, or may be commissioned from a reputable, independent third party information provider, such as Reuters. As many other manufacturers are likely to be located in similar regions or countries as the registering manufacturer, the cost of doing this work is controllable. The information obtained in this way may be updated periodically. This enables verification of a manufacturer's claim that, for example, it pays its staff in the top fifteen percent by staff grade level by comparison with comparable companies in the same sector in the geographic region and has the third best health and safety record.

The trusted, third party information that can be collected by, for example, product type, and location, e.g. industrial region or population centre within a country determined by sizes which give sufficient geographic homogeneity to be meaningful without being so small that the behaviour of any one supplier materially distorts the data sets. The rules and settings can be clearly explained to users and caveats on sources of information/information weakness provided as appropriate. Access to this information by the public may incur a fee which can be used to support such extra cost services.

The third party information can include, but is not limited to, area, geographic, cultural and political summary and history (content balanced to be factual rather than politicised or opinionated), regional economic data, population, earnings per capita, normal health, social, educational and income expectations by demographic grouping in the area, typical wages, working conditions, working hours, educational standards, types of work by grade of staff, typical environmental, health and safety and workplace standards (including Transparency Watch corruption index or similar) in the region, key manufacturers by segment in the region, key international investors and customers of local firms, comparison information by manufacturing segment (including size of firms, type of manufacturing—i.e. contract, subcomponent, “white label” own brand domestic sale, own brand international sale—and focus of sales, domestic versus international and where internationally.

At block S310, the trusted, third party information obtained at block S308 is overlaid automatically as a statistical summary that can be made available at extra charge to: the company to use internally, the company to show voluntarily on product information system 102, for the company to show and use with its trade customers and suppliers and investors, and/or to be looked at by prospective end retailers and/or customers for the goods. This allows retailers and/or customers to determine whether they like the look of where the product has come from and how the product scores against their “public view ethics” as well as their “personal private standard ethics”.

For an extra charge, the third party information provider may be commissioned by any of the aforementioned entities to do further personalised research either within preset “research templates” for a fixed fee or as open research on a “costed by project” basis.

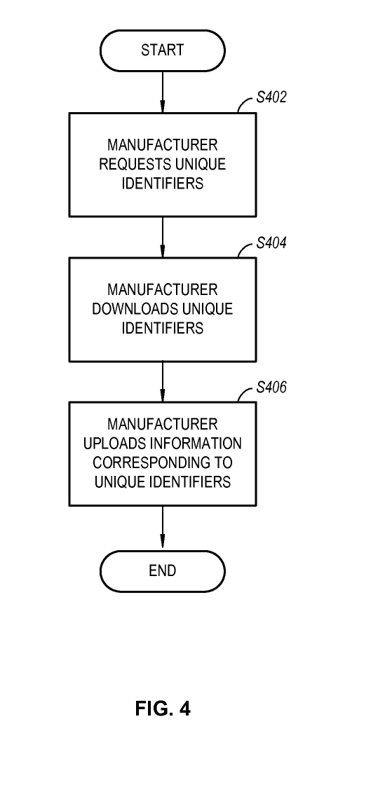

FIG. 4 is a process flow diagram illustrating the steps of matching products with information according to an embodiment. The process begins after the manufacturer is set up and validated on product information system 102, in accordance with the process described with reference to FIG.3 for example. At block S402, the manufacturer applies online for a set of unique identifiers, auto-generated by product information system 102. These can be paid for at a cost of, for example, $0.01 per unit for food products and items under $10 in retail price, $0.02 per unit for everything up to $50 in retail price, and $0.04 per unit for everything else the charges being set low enough that they will not materially affect margin on higher value products and can be identified as a still small premium for certainty on lower value products allowing a fractionally higher price to cover the added cost (for example, organic food trades at a premium for providing some assurance as to the production environment). After a fee has been paid, the manufacturer can download the unique identifiers (block S404). The manufacturer can then print the unique identifiers (e.g. in the form of a label affixed to or otherwise provided with a consumer product or added to the downloadable product sale information and sales receipt for electronic products such as software) and attach one unique identifier to each unit manufactured beside the serial number (if applicable). A duplicate may be attached to the outside of the packaging carton for ease of checking (end users will know to check that the carton label and the label on the product and the serial number on the product all match up). The unique identifiers may also include a web address of product information system 102 as well as a logo of the service provider of product information system 102.

At block S406, information corresponding to the unique identifiers is uploaded by the manufacturer to product information system 102. The uploaded information can include mandatory information and optional information.

Mandatory information can include, but is not limited to, the manufacturer of the product, the location of manufacture, the date and time of manufacture/production, product serial number (if applicable), a brief description of the product including type and model name, intended market(s) for end user purchase (for example based on languages printed in end user manual), and country-specific information (e.g. power supply type, languages in the user guide, safe and/or certified for use in the following countries). It is contemplated that product information system 102 includes a series of “templates” tailored to the product type, ranging from fruit to high performance sports cars. The templates may include mandatory information fields such as those just described, as well as optional information fields determined based on user and trade feedback. A certain amount of feedback may be required before an optional information field is added.

Other optional information can include, but is not limited to, detailed product specific information beyond the standard fields offered by product information system 102, such as market specific reviewer ratings and technical performance, optional upgrades and how to obtain them. This allows vendors to supply more information to customers without research cost or for customers to do their own comparison and analysis more easily.

Once the information is uploaded it will then be made accessible via product information system 102 to other users such as retailers and consumers. In one embodiment, the information associated with each unique identifier includes information identifying the owner of the corresponding product. By default, this may be the manufacturer who uploaded the information at block S406.

In one embodiment, the information from the manufacturer must be uploaded within a certain time period of the unique identifiers being downloaded. In one embodiment, if the expected market(s) is new to product information system 102, then the uploaded information and/or the information provided in the registration process described with reference to FIG. 3 can be translated. In one embodiment, the mandatory information is translated free of charge for the manufacturer whereas the optional information is translated at the manufacturer's expense. In this embodiment the costs of such translation activity may be capable of being spread over many users subsequent to the initial user given that many of the terms to be translated will be common to many products and manufacturers who may subsequently use the service in that market.

The manufacturer then ships the goods to market. It will be understood that the goods can appear in a physical store or on online space in the target market or even be sold directly by the manufacturer through a remote sales process (telephone, post or electronic conclusion of sale). As mentioned previously, the unique identifier provided by product information system 102 can be an extra field for the online or physical retailer to display when merchandising the product so that consumers can check the individual product's details before purchasing.

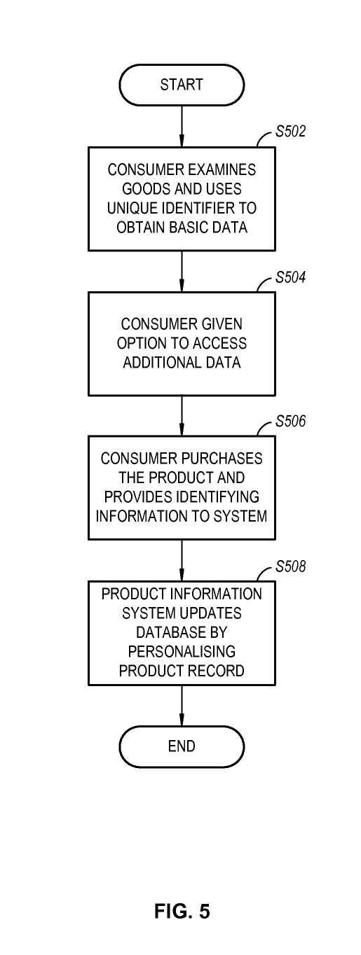

FIG. 5 is a process flow diagram illustrating the steps of providing information to consumers at a point of purchase.

At block S502, the consumer examines the goods and uses the unique identifier included by the manufacturer as a label on the goods or on the product description to connect to product information system 102, in order to use that identifier to obtain certain basic information such as the mandatory information uploaded by the manufacturer at block S406 of FIG. 4. The consumer may also be given free access to the mandatory public information and optional, free of charge public information obtained at block S304 of FIG. 3.

At block S504 the consumer is given the choice to access optional information for a payment, as has been described previously. The optional information may comprise at least part of the information provided at block S406 of FIG. 4 and the optional chargeable information obtained at blocks S304 and S308 of FIG. 3. The charge can be levied using, for example, a credit or debit card. Consumers can be encouraged to register with product information system 102 and provide a prepayment, by rewarding them with extra information for free. In one embodiment, the manufacturer can pay a small premium to make any of the optional chargeable information free to access.

At block S506, the consumer decides to purchase the product and, having done so, can then add extra information to the existing information held by the product information system 102, in order to confirm their ownership of the product as a safeguard against theft. On receipt of such information, the product information system 102 updates the information identifying the owner of the corresponding product (block S508). In embodiments, the update comprises storing and associating information identifying the consumer with the unique identifier of the product.

In embodiments, the vendor is required to be registered with product information system 102 in order to validate the “release” of the unique identifier to the consumer at block S508. Accordingly, the vendor may be required to validate its registration against the product, by seeking confirmation from the manufacturer, via product information system 102, that the manufacturer is satisfied that the vendor had legitimately purchased the product that it is about to sell, thereby further reducing the risk of theft and fraud within the logistics chain between the manufacturer and the end purchaser. In embodiments, vendor registration is part of the process by which the retailer provides product information to the purchaser. However, where the manufacturer had a committed order with a known retailer then the manufacturer may register this as part of the information that it uploads onto product information system 102. Thus, the default ownership information associated with a unique identifier may be information identifying the retailer. It will be understood that the ownership information is provided in addition to, and not instead of, the product and manufacturer information uploaded by the manufactures and third party information provider, and that changes to the ownership information do not alter the unique identifier or the product and manufacturer information. Rather, the unique identifier serves a ‘hook’ for linking ownership information to individual products.

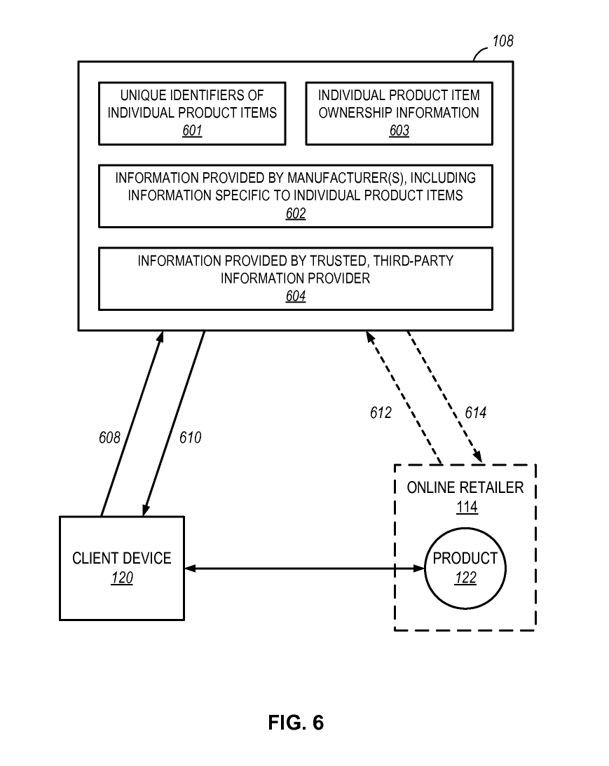

FIG. 6 schematically shows the interactions between a client device 120 and product information system 102. For clarity, only the database 108 of system 102 is shown. The database holds the information 602 provided by the manufacturers and the information 604 provided by the trusted, third party information provider, together with the unique identifier information 601 and ownership information 603 of the individual product items. The information is shown as being stored in separate blocks of information for convenience only. Different ways of storing and associating information in a database will be known to the skilled person.

The consumer or other entity such as the retailer, as the case may be, uses client device 120 to scan 606 or otherwise enter data representing the unique identifier. A request 608 including data representing the unique identifier is sent to the product information system 102, which is storing the information 602 provided by the manufacturer(s) and the information 604 provided by the trusted third-party information provider. The product information system 102 uses the data representing the unique identifier to identify the information corresponding to the unique identifier (i.e. corresponding to the product), and responds with a reply message 610 including, for example, the publicly available information provided by the manufacturer 112 of product 122. In embodiments, the product information system 102 is configured to provide the requested information in a standard format.

In embodiments, the product 122 and corresponding unique identifier (in electronic form) are presented on a website of an online retailer 114. In such cases, request 608 may be sent either directly to database server 108 or via the online retailer 114. For example, the online retailer 114 may send a request 612 for information to database server 108, in response to the user of the client device (in this case a consumer client device) clicking on a link, and receive a reply 614 including the requested information for display at the client device 120. In embodiments, where information requiring a payment is requested, the consumer may be charged by the product information system 102 (if registered for example) or by the online retailer 114. In particular, the consumer may have an existing account with online retailer 114 which can be used to deduct the relevant charges. In embodiments, the online retailer 114 may have obtained the publicly available information in advance, whereas the information requiring payment is requested from the product information system 102 in real time. Alternatively, the online retailer 114 may also have obtained the chargeable information from information distributor in advance, so that request 612 and response 614 are optional.

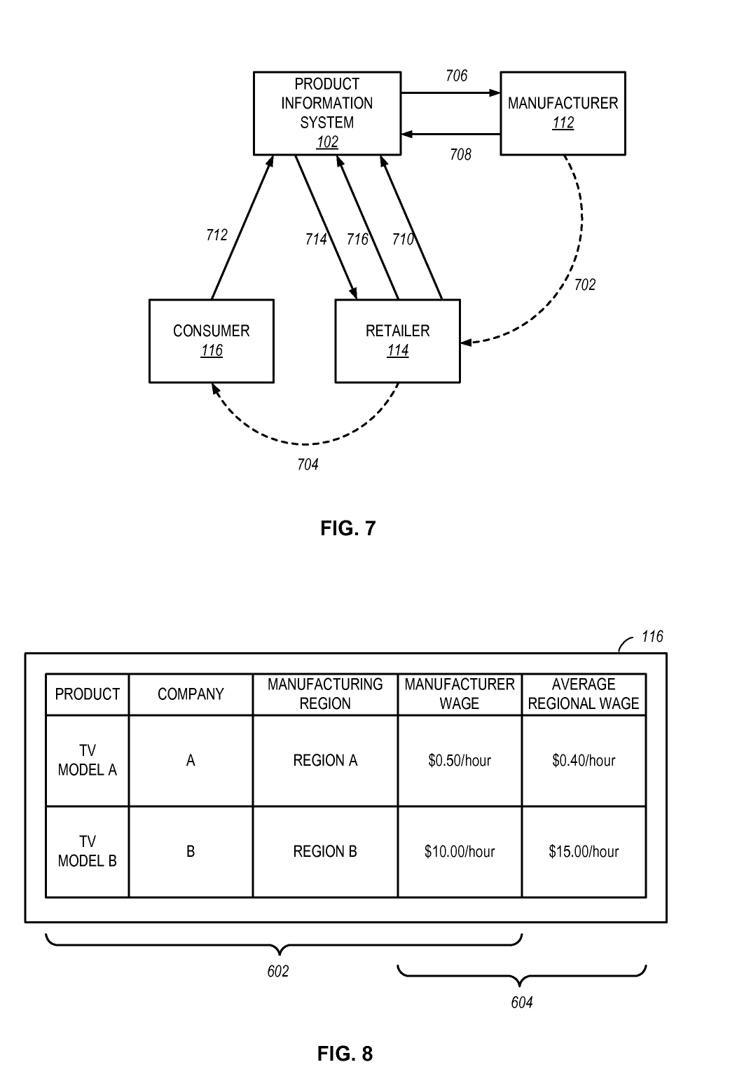

FIG. 7 schematically shows the interactions between product information system 102, manufacturer 112, retailer 114 and consumer 116 according to an embodiment in which ownership of a product item is first transferred 702 from the manufacturer to the retailer, and then transferred 704 from the retailer to the consumer. It will be appreciated that the principles are generally applicable to other product ownership transfers.

As explained with reference to FIG. 4, the manufacturer 112 downloads 706 unique identifiers from product information system 102 and subsequently uploads 708 the product and manufacturing information corresponding to the unique identifiers. Upon purchasing the product items, retailer 114 provides identifying information 710 to product information system 102 indicating that the product item has been purchased from manufacturer 112. The product information system 102 may request confirmation (not shown) from the manufacturer that the product item has indeed been purchased by retailer 114. Alternatively, the manufacturer 112 may already have provided this information as part of the uploaded information 708. In either case, the ownership information corresponding to the unique identifier is updated in the database of product information system 102.

When the consumer 116 purchases the product item from retailer 114, ownership is transferred 704 to the consumer 116. Information identifying the consumer 116 is then transmitted 712 to the product information system 102, for example by the consumer 116. Alternatively, the retailer 114 may provide this information (not shown). In the former case, the product information system 102 may seek confirmation 714 from the retailer 114 that the product has been purchased. Once confirmed 716, the ownership information for the product item is updated in the database of product information system 102. Updating the ownership information can include adding new ownership information to existing ownership information so that an auditable ownership trail is established, or replacing existing ownership information with the new ownership information.

Using the information provided by the manufacturers and the trusted information source, the consumer is able optionally to build a comparison table between all of the aforementioned free and paid-for information for several unique identifiers corresponding to the same product type (i.e. 48 inch flat screen TV) to perform a comparison of competing offerings in the same store or between products simultaneously available in different retailers (i.e. price, specification, provenance, factory conditions, and so on). For example, as shown in FIG. 8, a product description and company name obtained from the manufacturer can be shown free of charge to the client. Further information, such as the manufacturing region and wages, also provided by the manufacturer, can be shown for an extra charge. The manufacturer wage information can be verified by the trusted third party, which can also provide information about the average wage in the particular manufacturing regions.

Access to, and display of, the information can be achieved in a number of ways. For example, a mobile phone or other portable personal computer can be used whilst in store to input the unique number (e.g. by typing or using optical character recognition of a camera function) into a web browser or other application, at a store kiosk, at home on a personal computer (i.e. online shopping), or via an interactive voice and dial tone phone service (limited information) at the cost of a standard rate call.

Trade buyers may also access the information, for example, at a flat rate monthly charge per product type per range of searches made on the database based on most of the searchable fields and with the option to buy extra standard or specially commissioned data. In this way traders can be encouraged to use product information system 102 as part of their buying and sales and marketing activity.

Manufacturers of higher value goods are encouraged to use very hard to remove stickers to carry the product identifier but the product serial number is still recorded on the system along with a description so it could quickly become a default check on recovery of stolen goods to trace the owner via product information system 102 using the serial number and the unique identifier, if still present. If all of a certain manufacturer's product was known to be marked with unique identifiers from product information system 102 then the absence of the unique marker and/or of the product serial number would be indicative of their being something untoward about a product's ownership and therefore a reason to avoid purchase. Exemplary information that the consumer can provide includes the retailer from whom the product was purchased, date and time of purchase along with retailer invoice number. The use of such a service can entail a small charge, which would allow credit card/debit card validation to user which would act as an added security/identity/antifraud check. Information can also include contact details (police accessible only) and password information to control record entry. Second hand sales of product that is already registered with the product information system 102 can also be recognised through product information system 102 with the password protection preventing a thief from hacking in and changing details.

Although in foregoing embodiments reference is generally made to product that is to be purchased by a retailer or consumer, it will be appreciated that the product can be any manufactured, fabricated, assembled, or otherwise processed item, material or component. Thus, the product may represent a product that needs further processing and is supplied to, for example, another manufacturer. It may therefore be possible to trace the combination of two or more products into one new product (for example a car stereo, speakers and the car into which they are fitted)

Although in foregoing embodiments products with different unique identifiers are compared by the consumer, a particular product may be compared against other products of the same type made by the same manufacturer, and against a generic product of the same type made by a generic manufacturer.

Embodiments described herein can be implemented by software on a general purpose computer or in a combination of software and hardware. Thus each and every aspect of the embodiments described herein encompasses computer software implemented on a programmable device. The computer software can be provided to the programmable device using any conventional carrier medium.

Embodiments may be provided in the form of a computer program product on a carrier medium, which may be embodied in a passive storage medium, such as an optical or magnetic medium, or in an electronic medium, such as a mass storage device (e.g. a FLASH memory), or in a hardware device implemented to achieve execution of instructions, such as ASIC, an FPGA, a DSP or the like. Alternatively, the carrier medium can comprise a signal carrying the computer program code such as an optical signal, an electrical signal, an electromagnetic signal, an acoustic signal or a magnetic signal. For example, the signal can comprise a TCP/IP signal carrying the code over the Internet.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the scope of the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by those skilled in the art in light of the teachings and guidance.

The breadth and scope of the present invention should not be limited by any of the above-described exemplary embodiments, but should be defined only in accordance with the following claims and their equivalents.

1. A computer-implemented method of facilitating comparing and verifying of information, the method comprising:
receiving information relating to products and product supply chain operations from one or more sources, said one or more sources comprising at least one of a trusted third-party information provider and an entity associated with said products and product supply chain operations;
receiving information relating to an individual product item and a corresponding supply chain operation from a particular entity associated with said individual product item and said corresponding supply chain operation, the information relating to said individual product item including an identifier of said individual product item;
storing and associating the information received from said one or more sources with the information received from said particular entity in a database;
receiving a request for information from a potential purchaser of said individual product item, said request including said identifier;
looking up in the database information associated with said individual product item, using said identifier; and
transmitting at least part of said information associated with said individual product item to said potential purchaser.

2. The method of claim 1, further comprising:
receiving a request for identifiers from said particular entity; and
transmitting one or more identifiers that includes said identifier to said particular entity.

3. The method of claim 1, wherein said identifier is unique to said individual product item.

4. The method of claim 1, wherein the information transmitted to said potential purchaser is free of charge.

5. The method of claim 1, further comprising offering access to another part of said information associated with said individual product item that was not transmitted to said potential purchaser.

6. The method of claim 5, wherein said another part is accessible to said potential purchaser for a fee.

7. The method of claim 1, wherein said potential purchaser is an intermediate purchaser or an end user purchaser.

8. The method of claim 1, wherein the information stored in the database is associated according to a criterion comprising one or more of: a product type, an entity type, and a product supply chain operation location.

9. The method of claim 1, wherein said information relating to products and product supply chain operations comprises one or more of ethics related information and economic related information.

10. The method of claim 1, wherein said information relating to an individual product item and a corresponding supply chain operation comprises one or more of ethics related information and economic related information.

11. The method of claim 1, wherein said information relating to products and product supply chain operations comprises mandatory information and optional information.

12. The method of claim 1, wherein said information relating to an individual product item and a corresponding supply chain operation comprises mandatory information and optional information.

13. The method claim 1, further comprising:
receiving information indicating that said individual product item has been purchased;
receiving information identifying the purchaser; and
storing and associating the information identifying the purchaser with said identifier of said individual product item in the database.

14. An apparatus for facilitating comparing and verifying of information, the apparatus comprising:
a database that stores and associates information relating to products and product supply chain operations received from one or more sources with information relating to an individual product item and a corresponding supply chain operation received from a particular entity associated with said individual product item and said corresponding supply chain operation, wherein said one or more sources comprises at least one of a trusted third-party information provider and an entity associated with said products and product supply chain operations, and wherein said information relating to said individual product item includes an identifier of said individual product item;
a communication module configured to receive a request for information from a potential purchaser of said individual product item, said request including said identifier; and
a processor configured to look up information associated with said individual product item in said database, using said identifier;
wherein said communication module is further configured to transmit at least part of said information associated with said individual product item to said potential purchaser.

15. The apparatus of claim 14, wherein said communication module is further configured to:
receive a request for identifiers from said particular entity; and
transmit one or more identifiers that includes said identifier to said particular entity.

16. The apparatus of claim 15, wherein said one or more identifiers are generated by said processor in response to said request for identifiers.

17. The apparatus of claim 14, wherein said identifier is unique to said individual product item.

18. The apparatus of claim 14, wherein the information transmitted to said potential purchaser is free of charge.

19. The apparatus of claim 14, wherein said communication module is further configured to transmit an offer to said potential purchaser for access to another part of said information associated with said individual product item that was not transmitted.

20. The apparatus of claim 19, wherein said another part is accessible to said potential purchaser for a fee.

21. The apparatus of claim 14, wherein said potential purchaser is an intermediate purchaser or an end user purchaser.

22. The apparatus of claim 14, wherein the information stored in the database is associated according to a criterion comprising one or more of: a product type, an entity type, and a product supply chain operation location.

23. The apparatus of claim 14, wherein said information relating to products and product supply chain operations comprises one or more of ethics related information and economic related information.

24. The apparatus of claim 14, wherein said information relating to an individual product item and a corresponding supply chain operation comprises one or more of ethics related information and economic related information.

25. The apparatus of claim 14, wherein said information relating to products and product supply chain operations comprises mandatory information and optional information.

26. The apparatus of claim 14, wherein said information relating to an individual product item and a corresponding supply chain operation comprises mandatory information and optional information.

27. The apparatus of claim 14, wherein said communication module is further configured to receive information indicating that said individual product item has been purchased and information identifying the purchaser, and wherein the database stores and associates said information identifying the purchaser with said identifier of said individual product item in the database.

28. An apparatus for facilitating comparing and verifying of information, the apparatus comprising:
means for storing and associating information relating to products and product supply chain operations received from one or more sources with information relating to an individual product item and a corresponding supply chain operation received from a particular entity associated with said individual product item and said corresponding supply chain operation, wherein said one or more sources comprises at least one of a trusted third-party information provider and an entity associated with said products and product supply chain operations, and wherein said information relating to said individual product item includes an identifier of said individual product item;
means for receiving a request for information from a potential purchaser of said individual product item, said request including said identifier; and
means for looking up information associated with said individual product item in said database, using said identifier;
means for transmitting at least part of said information associated with said individual product item to said potential purchaser.

29. A computer-readable medium having stored thereon computer-executable instructions that, if executed by a computing device, configure the computing device to:
receive information relating to products and product supply chain operations from one or more sources, said one or more sources comprising at least one of a trusted third-party information provider and an entity associated with said products and product supply chain operations;
receive information relating to an individual product item and a corresponding supply chain operation from a particular entity associated with said individual product item and said corresponding supply chain operation, the information relating to said individual product item including an identifier of said individual product item;
store and associate the information received from said one or more sources with the information received from said particular entity in a database;
receive a request for information from a potential purchaser of said individual product item, said request including said identifier;
look up in the database information associated with said individual product item, using said identifier; and
transmit at least part of said information associated with said individual product item to said potential purchaser.

30. A database, comprising:
a storage medium storing and associating information relating to products and product supply chain operations obtained from one or more sources with information relating to an individual product item and a corresponding supply chain operation obtained from a particular entity associated with said individual product item and said corresponding supply chain operation, wherein said one or more sources comprises at least one of a trusted third-party information provider and an entity associated with said products and product supply chain operations, and wherein said information relating to said individual product item includes an identifier of said individual product item.

31. The database of claim 30, wherein the storage medium further stores and associates said identifier of said individual product item with information identifying an owner of said individual product.

32-39. (canceled)
